(19) United States
(12) Patent Application Publication
(10) Pub. No.: US 2024/0055861 A1
(43) Pub. Date: Feb. 15, 2024

(54) Systems and Methods for Balancing an Electric Load of a Three-Phase Water Heater

(71) Applicant: Rheem Manufacturing Company, Atlanta, GA (US)

(72) Inventors: Hiram Osuna CARRASCO, Atlanta, GA (US); Jesus LOPEZ, Atlanta, GA (US); Venkata Rama Gautham Devarakonda, Atlanta, GA (US); Li Xin Li, Atlanta, GA (US)

(21) Appl. No.: 18/446,817

(22) Filed: Aug. 9, 2023

Related U.S. Application Data
(60) Provisional application No. 63/371,185, filed on Aug. 11, 2022.

(51) Int. Cl. H02J 3/26; H05B 1/02

(52) U.S. Cl. CPC H02J 3/26; H05B 1/0244; H02J 2310/12

(57) ABSTRACT

Systems and methods for detecting a power imbalance in a three-phase electric fluid heater and selectively deactivating heating elements to maintain functionality in a reduced power state are provided. Methods include detecting a faulty or malfunctioning heating element in a three-phase electrical connection, determining counterpart heating elements in non-faulty legs of the three-phase electrical connection, deactivating select heating elements in each non-faulty leg of the three-phase electrical connection, and maintaining output of the electrical heater at a reduced power setting. Similarly, heating elements in each leg may be selectively deactivated to reduce power consumption in a fluid heater system in response to reduced demand or grid requirements.

### CROSS-REFERENCE TO RELATED APPLICATION

This application claims the benefit of U.S. application Ser. No. 63/371,185, filed Aug. 11, 2022, the entirety of which is hereby incorporated by reference.

### TECHNICAL FIELD

The present disclosure is generally in the field of electrical heater systems. For example, systems and methods are provided herein for balancing an electrical load on a three-phase electrical fluid heater system.

### BACKGROUND

Electrical heat systems conveniently and efficiently heat water for residential and commercial use. Three-phase heater systems are often employed in such heater systems. Typically, a delta or star electrical connection with three legs and heating elements on each leg are employed to heat a fluid in the heat system, such as water. A leg may be one or more electrical connections in electrical communication with a power unit, having at least one heating element, and joined to another leg on at least one end. For example, a delta connection is made up of three legs, with each leg having a heating element and joined to another leg on at least one end. The heating elements directly interface with the fluid. As current is introduced through the electrical system and thus the heating elements, the heating elements generate heat that is transferred to the surrounding fluid, thereby heating the fluid in contact with the heating elements.

While the three-phase delta and star connections, each having a three-leg electrical structure, have proven to be efficient and effective systems for heating a fluid such as water, the three-legged architecture is occasionally the reason for electrical failure and ultimately system failure. In the delta and star electrical connections, each of the three-legs must be balanced in that the current and power corresponding to each leg must the same. If one leg experiences a failure, the system becomes unbalanced, which can result in system damage and failure.

As the heating elements of such heater systems are positioned in the fluid themselves, over time it is possible for corrosive forces to affect the heating elements. Over time the resistance of such heating elements may change. For example, corrosion may damage the heating element. It is even possible for the heating element to sever, resulting in an open circuit. When the resistance varies between heating elements on each leg of the connection, the electrical load will become unbalanced and the entire system will have to be shut down to avoid any further damage.

Accordingly, there is a need for improved methods and systems for balancing an electrical load in an electrical heater upon failure of one-leg of the electrical system to maintain heat production.

### BRIEF DESCRIPTION OF THE DRAWINGS

FIG. 1 is a schematic illustration of one embodiment of a heater system performing electrical load balancing.

FIG. 2 is a schematic illustration of one embodiment of a delta circuit for a three-phase water heater providing load balancing control.

FIG. 3 is a schematic illustration of one embodiment of a star circuit for a three-phase water heater providing load balancing control.

FIG. 4 illustrates an exemplary process flow for balancing a three-phase heater system.

FIG. 5 illustrates an exemplary process flow for balancing a three-phase heater system with multiple failures.

FIG. 6 is a schematic block diagram of a heater system in accordance with one or more example embodiments of the disclosure.

### DETAILED DESCRIPTION

Improved heater systems and controls have been developed which are capable of detecting an imbalance in the electrical load across a three-legged electrical connection due to a failure in a heating element, and adjusting the electrical distribution across the other legs of the electrical connection to balance the electrical load to continue to operate the heater system at a reduced power setting. A three-legged electrical connection may have three legs, with each leg in electrical communication with a power unit, having a heating element, and joined to two more legs. Accordingly, by balancing the load, the heater system may be de-rated to avoid catastrophic failure and continue heat output without damage to the heat system. The improved heater systems and controls may continue to detect subsequent imbalances in the electrical load and adjust electrical distribution to continue safe operation of the heater system without distributing heat output.

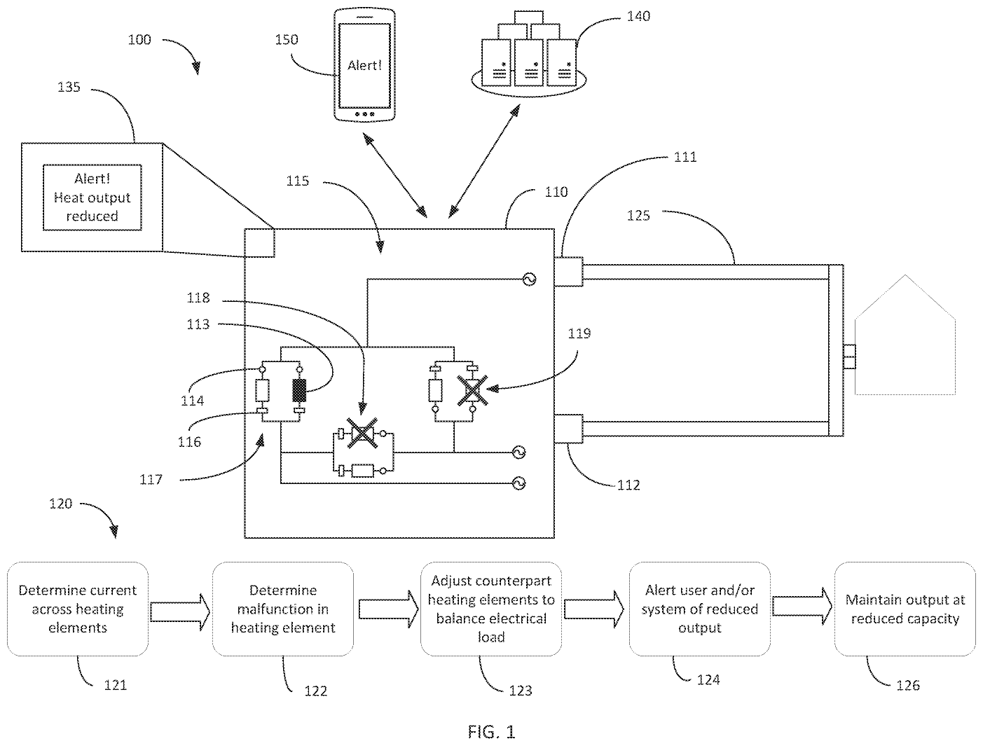

Referring now to FIG. 1, a heater system designed to load balance to continue heat output despite an imbalance in the electrical load is illustrated. Specifically, heater system 100 may include heater 110, plumbing system 125, server 140 and/or mobile device 150. Heater system 100 may be an electrical fluid heater that may be a three-phase water heater, for example, and may be in fluid communication with pluming system 125 which may include well-known plumbing fixtures that connect heater 110 to a residential or commercial structure.

The heater may be a three-phase fluid heater that uses multiple heating elements in contact with the fluid to transfer heat from the heating elements to the fluid to heat the fluid. In one embodiment, heater 110 may be similar to U.S. Pat. No. 11,067,311, which describes a three-phase water heater and is hereby incorporated by reference. However, it is understood that heater 110 may be any three-phase electric fluid heater. Heating elements of heater 110 may be positioned upon a multi-legged electrical connection positioned, at least partially, within a flow path of the heater 110. Heating elements may be any well-known resistive (e.g., resistors) and/or other heating elements for heating fluid.

Heater 110 may include a fluid input 111 and a fluid output 112 connected to plumbing system 125 and a flow path positioned between fluid input 111 and fluid output 112. Heating elements (e.g., heating element 113) of electrical system 115 may be positioned within the flow path. For example, electrical system 115 may include any well know electrical connection and/or circuits with heating elements, such as a delta connection or a star connection, for example. Heating element 113 may be any well-known electric resistor for water heaters. Alternatively, heating element 113 may be any other well-known heating element. Electrical system 115 may further include transformers 114, which may be any well-known transformer (e.g., a current transformer rings) and relays 116, which may be any well-known relay (e.g., solid state relay). Alternatively, contactors may be used instead of relays. It is understood that electrical system 115 may include any number of heating elements (e.g., 3, 6, 9, 12, etc.).

Heater system 100 may further include controller 135 which may be coupled to, in communication with, and/or incorporated into heater 110. Controller 135 may be a computing device with one or more processors and may optionally include a display as shown in FIG. 1. Controller 135 may be responsible for controlling the operation of heater 110, including the electrical power distribution across electrical system 115 and may balance the electrical load across electrical system 115 in response to a faulty heating element and/or to reduce power consumption.

Controller 135 may further be in electrical communication with transformers 114 and relays 116. Controller 135 may receive a signal or other information from transformers 114 that may be indicative of a current in leg or branch of electrical system 115. Controller 135 may further be in electrical communication with relay 116 that may be positioned on the legs and/or branches of the electrical system. Controller 135 may know the spatial position of each heating element 113, transformer 114, and relay 116 with respect to the electrical system 115 and may associate one or more heating element 113, transformer 114 and/or relay 116 as being positioned on the same leg or branch in electrical system 115. For example, controller 135 may associate relay 116 and transformer 114 for being positioned on the same branch.

Controller 135 may be in communication one or more other computing devices such as mobile device 150 and/or server 140. Server 140 may be one or more computing devices that may be located remotely from controller 135. Mobile device 150 may be any computing device such as a smartphone, tablet, smartwatch, smart-glasses, any other type or wearable, and the like. Controller 135 may be in communication with server 140 and/or mobile device 150 via any well-known wired or wireless system (e.g., Bluetooth, Bluetooth Low Energy (BLE), near field communication protocol, Wi-Fi, cellular network, etc.). It is understood that controller 135 may communicate directly with mobile device 150 and/or mobile device 150 may communicate indirectly with controller 135 via server 140. For example, server 140 may serve as a communication intermediary between mobile device 150 and controller 135.

Server 140 and/or controller 135 may be in communication with other systems such as other heater systems, other heating, ventilation, and air conditioning (HVAC) systems, other plumbing systems, security systems and/or any other well-known residential or commercial structure systems. It is understood that any decisions, functions and/or operations performed by controller 135 may be performed solely by controller 135, by controller 135 in conjunction with server 140 and/or by server 140 and implemented or otherwise executed by controller 135. In one embodiment, server 140 may coordinate water heating of multiple water heater systems in a residential or commercial building.

Mobile device 150 may be used to control and/or adjust operation of controller 135. For example, mobile device 150 may be used to switch controller 135 and thus heater 110 into a low power mode (e.g., if building capacity is expected to be reduced or if necessitated by grid limitations). Further, controller 135 may send alerts, alarms and/or messages to mobile device 150 to inform a user of mobile device 150 of a change in operating function and/or parameters of heater 110 and/or a failure in heater 110. For example, controller 135 may send mobile device 150 a message that heat and/or power output of heater 110 has been reduced.

To initiate the actions of determining an imbalance in the electrical system 115 of a heater 110 and determining to balance the electrical load, example process flow 120 is presented and may be performed, for example, by one or more modules at controller 135 and/or server 140. At a block 121, controller 135 may determine and/or obtain a signal or information indicative of the current across heating elements. For example, electrical system 115 may include transformers 114 on each leg of the electrical system 115 and even, as shown in FIG. 1, each branch of each leg of electrical system 115. Transformers 114 may detect current flowing through each branch.

At block 122, controller 135 may analyze the current determined from each transformer 114. Controller 135 may be preset with a normal range of current values and/or signal values expected from legs or branches of electrical system 115 with properly functioning heating elements. Controller 135 may compare the current values obtained from each transformer and compare to an expected value or range to determine if the received value is the same as the expected value or falls with the expected range.

If it is determined that the measured values from the transformers are not the same as the normal value and/or range, controller 135 may determine that a heating element corresponding to the branch of electrical system 115 with the abnormal current reading has malfunctioned. When the measured values do not match the expected normal value and/or range, the electrical system is experiencing an electrical load imbalance.

At block 123, controller 135 may adjust heating elements that are determined to be counterpart heating elements of the faulty heating element. Controller 135 may also optionally eliminate power to the faulty heating element using a relay in electrical communication with the faulty heating element. For example, controller 135 may identify the non-effected legs of the electrical systems and identify counterpart heating elements on each non-effected leg. As shown in FIG. 1, electrical system 115 includes first leg 117, second leg 118 and third leg 119.

Controller might determine that heating element 113 of first leg 117 is not working property (e.g., the current reading is not a normal value) and therefore might determine that such fault has resulted in an open circuit. To balance the electrical load, controller may eliminate power to a corresponding heating element of second leg 118 and third leg 119 via relays in electrical communication with each respective counterpart heating element. It is understood that each heating element may have the same resistance value and thus deactivating a single heating element on each legal successfully balances the electrical load as each leg now has a single heating element.

At optional block 124, controller may inform mobile device 150 and/or server 140 of the faulty heating element, the adjustment made to electrical system 115, and/or the reduced power out after the adjustment is made. For example, controller 135 may send a message to mobile device 150 alerting a user that heater 110 has experienced a faulty heating element and that power has been reduced to maintain heat output. Additionally or alternatively, heater 110 may send data about the faulty heating element to server 140. For example, heater 110 may send data about which heating element failed, which non-faulty heating element has been powered off to balance the load, and what the power output is. Similar information may be displayed on an optional display of controller 135, which may be part of heater 110 or may be a separate device.

At block 126, controller may cause heater 110 to continue to heat the fluid (e.g., water) even if at a reduced power capacity. For example, if each leg of electrical system 115 includes two resistor elements, and one resistor element has been deactivated on each leg, the power capacity of electrical system 115 has been cut in half, but heater 110 may continue to heat the fluid at a half the power without having to shut down completely to avoid catastrophic failure.

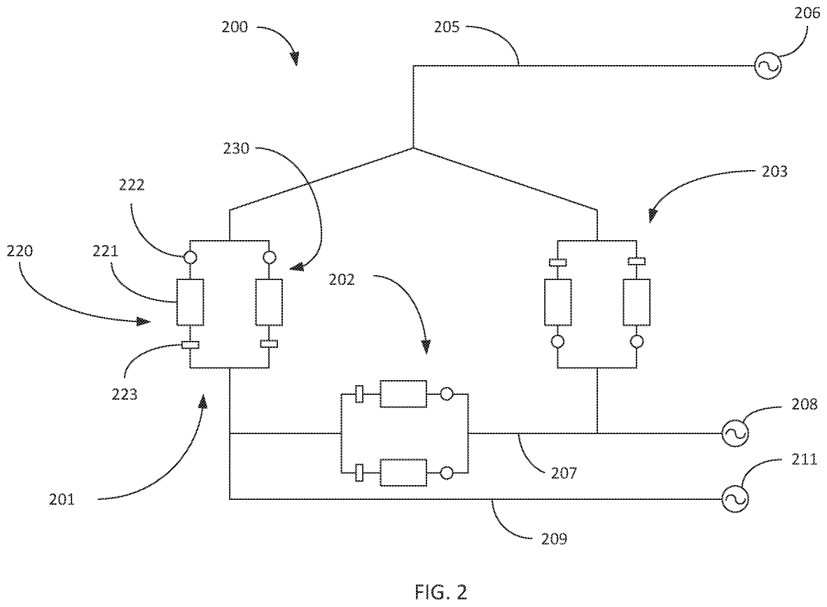

Referring now to FIG. 2, delta connection 200 is illustrated. Electrical system 115 illustrated in FIG. 1 may include delta connection 200. Delta connection 200 may support three phases with three distinct legs of delta connection 200. For example, delta connection 200 may include first leg 201, second leg 202, and third leg 203. First leg 201, second leg 202, and third leg 203 may be arranged in a delta configuration. Electrical connection 205 may connect to both first leg 201 and second leg 203 and may be powered by power unit 206. Electrical connection 207 may connect to both second leg 202 and second leg 203 and may be powered by power unit 208. Electrical connection 209 may connect to both first leg 201 and second leg 203 and may be powered by power unit 211.

Each of leg 201, second leg 202, and third leg 203 may have be made up of two or more branches that are arranged in parallel. While FIG. 2 illustrates two branches per leg, it is understood that each leg may include any number of branches, provided that that each leg includes the same number of heating elements and each heating element has the same resistance. For example each leg may include three or four branches in parallel, each with its own, relay, heating element and transformer.

As shown in FIG. 2, each leg (i.e., first leg 201, second leg 202, and third leg 203) may include two branches (e.g., first branch 220 and second branch 230 of first leg 201). Each branch of each leg may include a heating element (e.g., heating element 221), a relay (e.g., relay 223), and a transformer (e.g., transformer 222). It is understood that heating element 221 may be the same as or similar to heating element 113, relay 223 may be the same or similar to relay 116, and/or transformer 222 may be the same or similar to transformer 114 of FIG. 1.

A controller (e.g., controller 135 of FIG. 1) may be in electrical communication with each transformer (e.g., transformer 222) and each relay (e.g., relay 223). As each branch of each leg of delta connection 200 may include a relay and a transformer, the controller may associate each transformer with a respective relay and upon identifying a malfunctioning or faulty heating element based on a current reading from a certain transformer, the respective relay corresponding to the transformer in question may be manipulated to deactivate a heating element positioned on the same branch. The controller may also keep track of which legs have faulty or malfunctioning heating elements.

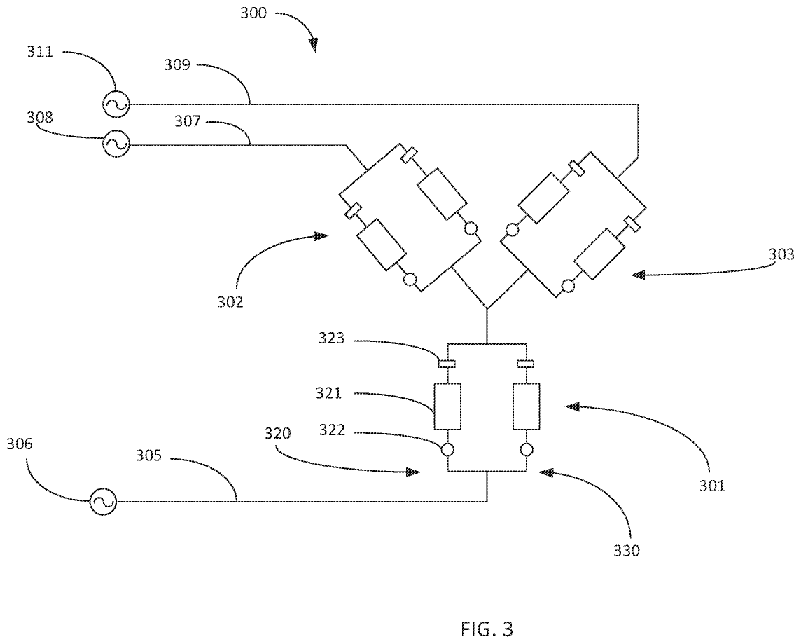

Referring now to FIG. 3, star circuit 300 is illustrated. As an alternative to delta connection 200 of FIG. 2, electrical system 115 illustrated in FIG. 1 may include star circuit 300. Star circuit 300 may similarly support three distinct legs of star circuit 300. For example, star circuit 300 may include first leg 301, second leg 302, and third leg 303. First leg 301, second leg 302, and third leg 303 may be arranged in a star configuration. Electrical connection 305 may connect to first leg 301 and may be powered by power unit 306. Electrical connection 307 may connect to second leg 302 and may be powered by power unit 308. Electrical connection 309 may connect to third leg 303 and may be powered by power unit 311.

Similar to delta connection 200 of FIG. 2, each of leg 301, second leg 302, and third leg 303 may be made up of two or more branches that are arranged in parallel. While FIG. 3 illustrates two branches per leg, it is understood that each leg may include any number of branches, provided that that each leg includes the same number of heating elements and each heating element has the same resistance. For example, each leg may include three or four branches in parallel, each with its own, relay, heating element and transformer.

As shown in FIG. 3, each leg (i.e., first leg 301, second leg 302, and third leg 303) may include two branches (e.g., first branch 320 and second branch 330 of first leg 301). Each branch of each leg may include a heating element (e.g., heating element 321), a relay (e.g., relay 323), and a transformer (e.g., transformer 322). It is understood that heating element 321 may be the same as or similar to heating element 113, relay 323 may be the same or similar to relay 116, and/or transformer 322 may be the same or similar to transformer 114 of FIG. 1.

Similar to delta connection 200 of FIG. 2, a controller (e.g., controller 135 of FIG. 1) may be in electrical communication with each transformer (e.g., transformer 322) and each relay (e.g., relay 323) of star connection 300. As each branch of each leg of star circuit 300 may include a relay and a transformer, the controller may associate each transformer with a respective relay and upon identifying a malfunctioning or faulty heating element based on a current reading from a certain transformer, the respective relay corresponding to the transformer in question may be manipulated to deactivate a heating element positioned on the same branch. The controller may also keep track of which legs have faulty or malfunctioning heating elements.

While each of delta connection 200 of FIG. 2 and star connection 300 of FIG. 3 may be manipulated by a controller (e.g., controller 135 of FIG. 1) if a faulty heating element is detected to balance the electrical load and continue operation of the electric heater at a reduced power capacity, it is understood that delta connection 200 of FIG. 2 and star connection 300 of FIG. 3 may alternatively or additionally be used to reduce power output as desired. For example, a user may determine that for a certain period of time, use and/or demand for the heater will be reduced, and as a result, a user may selectively deactivate one or more heating elements on each leg to reduce the power output of the electric heater. Alternatively, this technique may be employed when there is a grid requirement or limitation that must be satisfied.

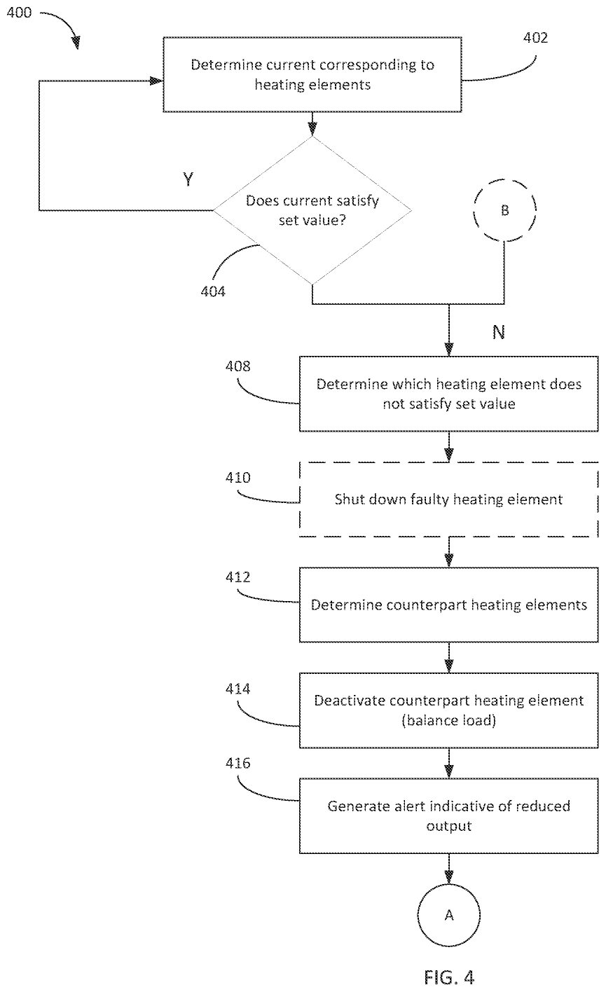

Referring now to FIG. 4, an example process flow 400 for detecting a faulty or otherwise malfunctioning heating element and balancing a three-phase heater for reduced power but continued operation is illustrated. The heater in process flow 400 may be the same or similar to heater 110 of FIG. 1 and may include a controller (e.g., controller 135 of FIG. 1) and a delta connection (e.g., delta connection 200 of FIG. 2). While process flow 400 is described with respect to a delta connection, it is understood that the same process may be applied for a star connection (e.g., star connection 300 of FIG. 3).

While example embodiments of the disclosure may be described in the context of a controller, it should be appreciated that the disclosure is more broadly applicable to various types of computing devices as well as a controller in combination with a computing device, such as a server. Some or all of the blocks of the process flows in this disclosure may be performed in a distributed manner across any number of devices. The operations of process flow 400 may be optional and may be performed in a different order.

At block 402, computer-executable instructions stored on a memory of a device, such as a controller, may be executed to determine a current corresponding to various heating elements. As shown in the delta connection of FIG. 2, each heating element may be accompanied by a transformer such as a current transformer ring, for example. Each transformer may be in electrical communication with the controller and may generate a signal indicative of the current across each heating element. Controller may receive each signal and may determine a current value or other value representative of the current of the heating elements.

At decision 404, computer-executable instructions stored on a memory of a device, such as a controller, may be executed to determine whether the current value satisfies a set value. The set value may be a value or range of values corresponding to a normal properly functioning heating element. If all the measured values determined at block 402 satisfy the set value, block 402 may be repeated. However, if at least one of the measured values determined at block 402 does not satisfy the set value, block 408 will be initiated.

At block 408, computer-executable instructions stored on a memory of a device, such as a controller, may be executed to determine which heating element does not satisfy the set value corresponding to a normal properly functioning heating element. The controller may know the position of each transformer and/or heating element (e.g., on which branch of the delta connection), and may identify which heating element corresponds to a transformer that generated the signal with a current value that is less than or otherwise does not satisfy the set value.

At optional block 410, computer-executable instructions stored on a memory of a device, such as a controller, may be executed to shut down the faulty or otherwise malfunctioning heating element corresponding to the transformer that generated the signal that does not satisfy the set value. For example, the electrical system may include a relay for each heating element that may be actuated to deactivate a particular heating element. The controller may log that the heating element has been deactivated.

At block 412, computer-executable instructions stored on a memory of a device, such as a controller, may determine a counterpart heating element on each of the other legs of the delta connection. For example, if the faulty or malfunctioning heating element is determined by the controller to be on the first leg, the controller may select a heating element on the second leg and on the third leg of the delta connection to deactivate using relays corresponding to each heating element. At block 414, computer-executable instructions stored on a memory of a device, such as a controller, may cause the counterpart heating elements identified at block 412 to be deactivated, thereby balancing the electrical load on the delta connection. The controller may log which heating elements have been deactivated.

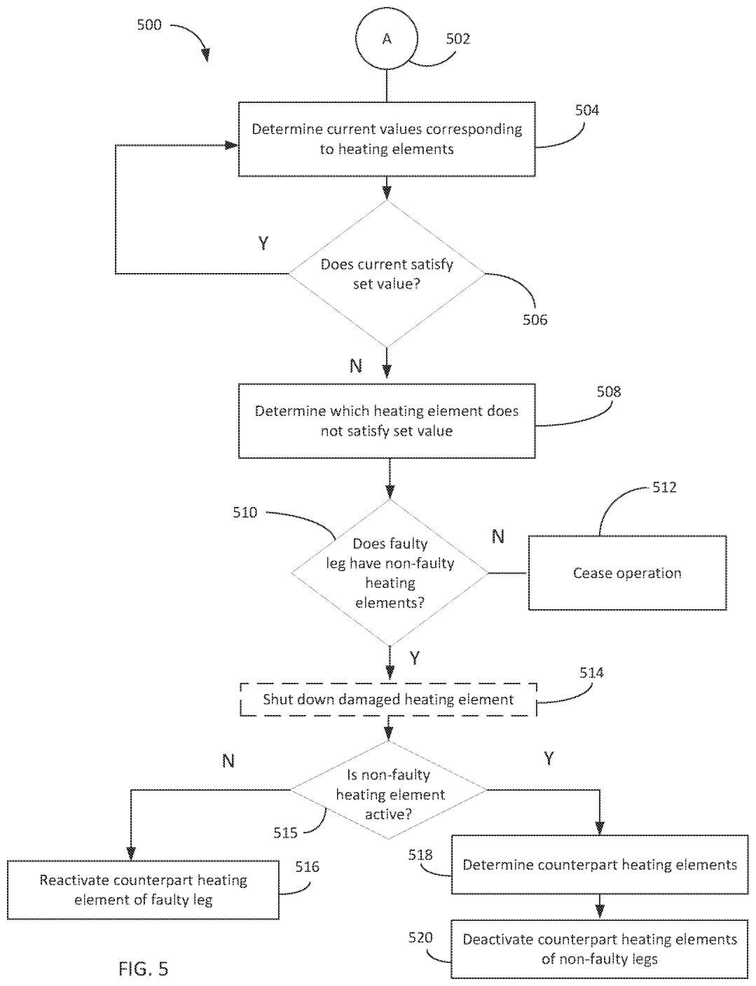

At block 416, computer-executable instructions stored on a memory of a device, such as a controller, may generate an alert indicative of the current values, the heating elements corresponding to the current values, the faulty or malfunctioning heating element, the heating elements that have been deactivated, and/or any other relevant information corresponding thereto. The alert may be sent from the controller to a server (e.g., server 140 of FIG. 1), a mobile device (e.g., mobile device 150 of FIG. 1), or any other computing device or system (e.g., a different heater system). The process may end at point “A” or may continue on with the process flow in FIG. 5.

Referring now to FIG. 5, an example process flow 500 for detecting a second or more faulty or otherwise malfunctioning heating element and balancing a three-phase heater electrical system for reduced power but continued operation is illustrated. The heater in example process flow 500 may be the same or similar to heater 110 of FIG. 1 and may include a controller (e.g., controller 135 of FIG. 1) and a delta connection (e.g., delta connection 200 of FIG. 2). While the process flow is described with respect to a delta connection, it is understood that the same process may be applied for a star connection (e.g., star connection 300 of FIG. 3).

While example embodiments of the disclosure may be described in the context of a controller, it should be appreciated that the disclosure is more broadly applicable to various types of computing devices as well as a controller in combination with a computing device, such as a server. Some or all of the blocks of the process flows in this disclosure may be performed in a distributed manner across any number of devices. The operations of the process flow 500 may be optional and may be performed in a different order.

Process flow 500 may be initiated at point “A” which may occur after block 416 of FIG. 4. At block 502, computer-executable instructions stored on a memory of a device, such as a controller, may be executed to determine a current corresponding to various heating elements of the delta connection. Each heating element may be accompanied by a transformer such as a current transformer ring, for example, which may generate a signal indicative of the current across each heating element.

At decision 506, computer-executable instructions stored on a memory of a device, such as a controller, may be executed to determine whether the current value satisfies a set value. The set value may be current value or range of current values corresponding to a normal properly functioning heating element. If all the measured values determined at block 504 satisfy the set value, block 504 may be repeated. However, if at least one of the measured values determined at block 504 does not satisfy the set value, block 508 will be initiated. It is understood that any measured values corresponding to heating elements that have been deactivated and/or previously determined to be faulty may be disregarded.

At block 508, computer-executable instructions stored on a memory of a device, such as a controller, may be executed to determine which heating element does not satisfy the set value corresponding to a normal properly functioning heating element. The controller may know the position of each transformer and/or heating element (e.g., on which branch of the delta connection), and may identify which heating element corresponds to a transformer that generated the signal with a current value that is less than or otherwise does not satisfy the set value.

At decision 510, computer-executable instructions stored on a memory of a device, such as a controller, may be executed to determine whether the leg of the delta connection on which the faulty or malfunctioning resistor is located has other non-faulty heating elements. If the leg does not have other non-faulty heating elements, at block 512 computer-executable instructions stored on a memory of a device, such as a controller, may be executed to cease operation of the heater. However, if the leg does have other non-faulty heating elements, blocks 514-520 will be initiated.

At optional block 514, computer-executable instructions stored on a memory of a device, such as a controller, may be executed to shut down the faulty or otherwise malfunctioning heating element corresponding to the transformer that generated the signal that does not satisfy the set value. At decision 515, computer-executable instructions stored on a memory of a device, such as a controller, may be executed to determine if the non-faulty heating element on the faulty leg is currently active. At block 518, if the non-faulty heating element of the faulty leg is currently deactivated (e.g., if it has previously been deactivated to balance the electrical load for a previous faulty heating element), computer-executable instructions stored on a memory of a device, such as a controller, may determine that it is necessary to reactivate counterpart heating elements and cause such elements to be reactivated. By reactivating the heating element, the electrical load of the delta connection may be balanced.

However, if it is determined that the non-faulty heating element is active, at block 518 computer-executable instructions stored on a memory of a device, such as a controller, may determine a counterpart heating element on each of the other legs of the delta connection. For example, if the faulty or malfunctioning heating element is determined by the controller to be on the first leg, the controller may select a heating element on the second leg and on the third leg of the delta connection to deactivate using relays corresponding to each heating element. At block 520, computer-executable instructions stored on a memory of a device, such as a controller, may cause the counterpart heating elements identified at block 518 to be deactivated, thereby balancing the electrical load on the delta connection. The controller may log which heating elements have been reactivated and/or deactivated.

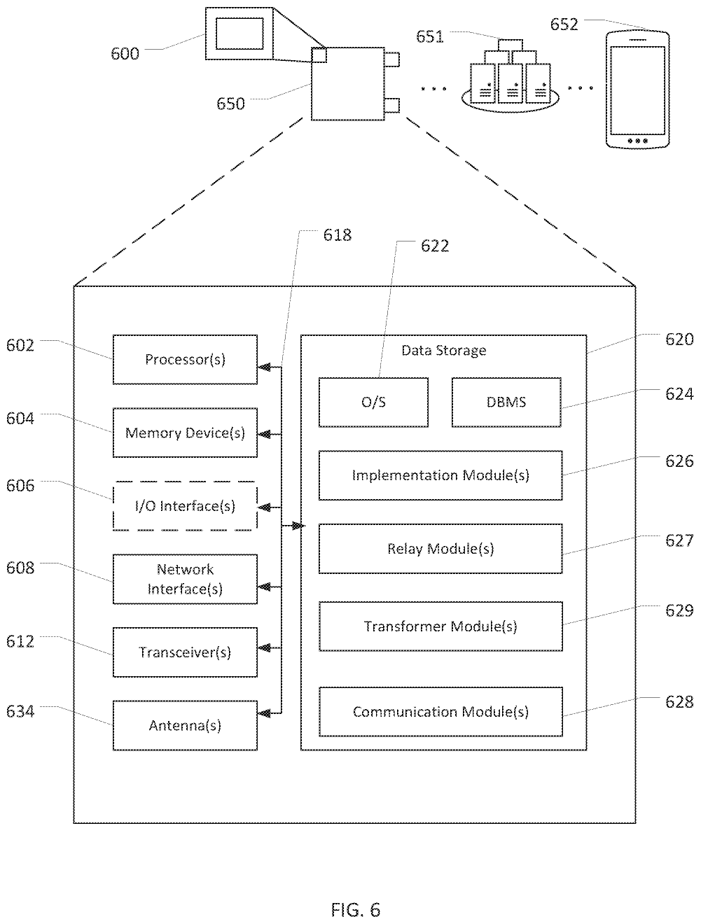

FIG. 6 is a schematic block diagram of an illustrative controller 600, which may be incorporated into a heater 650, in accordance with one or more example embodiments of the disclosure. Controller 600 may be the same or similar to controller 135 of FIG. 1 and heater 650 may be the same or similar to heater 110 of FIG. 1 and/or may be an illustrative device configuration for the device(s) that includes one or more of the controllers and heaters of FIGS. 1-5.

The controller 600 may be configured to communicate with one or more servers (e.g., server 651, which may be the same or similar to server 140 of FIG. 1), mobile devices (e.g., mobile device 652, which may be the same or similar to mobile device 150 of FIG. 1), user devices, other systems, or the like. It is understood that one or more components of controller 600 may be alternatively or additionally incorporated into server 651 and/or mobile device 652.

Controller 600 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks.

In an illustrative configuration, controller 600 may include one or more processors 602, one or more memory devices 604 (also referred to herein as memory 604), one or more input/output (I/O) interface(s) 606, one or more network interface(s) 608, one or more transceiver(s) 610, one or more antenna(s) 634, and data storage 620. The controller 600 may further include one or more bus(es) 618 that functionally couple various components of the controller 600.

The bus(es) 618 may include at least one of a system bus, a memory bus, an address bus, or a message bus, and may permit exchange of information (e.g., data (including computer-executable code), signaling, etc.) between various components of the controller 600. The bus(es) 618 may include, without limitation, a memory bus or a memory controller, a peripheral bus, an accelerated graphics port, and so forth. The bus(es) 618 may be associated with any suitable bus architecture including.

The memory 604 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In various implementations, the memory 604 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth.

The data storage 620 may include removable storage and/or non-removable storage including, but not limited to, magnetic storage, optical disk storage, and/or tape storage. The data storage 620 may provide non-volatile storage of computer-executable instructions and other data. The memory 604 and the data storage 620, removable and/or non-removable, are examples of computer-readable storage media (CRSM) as that term is used herein. The data storage 620 may store computer-executable code, instructions, or the like that may be loadable into the memory 604 and executable by the processor(s) 602 to cause the processor(s) 602 to perform or initiate various operations. The data storage 620 may additionally store data that may be copied to memory 604 for use by the processor(s) 602 during the execution of the computer-executable instructions. Moreover, output data generated as a result of execution of the computer-executable instructions by the processor(s) 602 may be stored initially in memory 604, and may ultimately be copied to data storage 620 for non-volatile storage.

The data storage 620 may store one or more operating systems (O/S) 622; one or more optional database management systems (DBMS) 624; and one or more program module(s), applications, engines, computer-executable code, scripts, or the like such as, for example, one or more implementation modules 626, relay modules 637, one or more transformer modules 628, and one or more communication modules 628. Some or all of these modules may be sub-modules. Any of the components depicted as being stored in data storage 620 may include any combination of software, firmware, and/or hardware. The software and/or firmware may include computer-executable code, instructions, or the like that may be loaded into the memory 604 for execution by one or more of the processor(s) 602. Any of the components depicted as being stored in data storage 620 may support functionality described in reference to correspondingly named components earlier in this disclosure.

Referring now to other illustrative components depicted as being stored in the data storage 620, the 0/S 622 may be loaded from the data storage 620 into the memory 604 and may provide an interface between other application software executing on the controller 600 and hardware resources of the controller 600. More specifically, the 0/S 622 may include a set of computer-executable instructions for managing hardware resources of the controller 600 and for providing common services to other application programs (e.g., managing memory allocation among various application programs). In certain example embodiments, the 0/S 622 may control execution of the other program module(s) to for content rendering. The O/S 622 may include any operating system now known or which may be developed in the future including, but not limited to, any server operating system, any mainframe operating system, or any other proprietary or non-proprietary operating system.

The optional DBMS 624 may be loaded into the memory 604 and may support functionality for accessing, retrieving, storing, and/or manipulating data stored in the memory 604 and/or data stored in the data storage 620. The DBMS 624 may use any of a variety of database models (e.g., relational model, object model, etc.) and may support any of a variety of query languages. The DBMS 624 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like.

The optional input/output (I/O) interface(s) 606 may facilitate the receipt of input information by the controller 600 from one or more I/O devices as well as the output of information from the controller 600 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; and so forth. Any of these components may be integrated into the controller 600 or may be separate.

The controller 600 may further include one or more network interface(s) 608 via which the controller 600 may communicate with any of a variety of other systems, platforms, networks, devices, and so forth. The network interface(s) 608 may enable communication, for example, with one or more wireless routers, one or more host servers, one or more web servers, and the like via one or more of networks.

The antenna(s) 634 may include any suitable type of antenna depending, for example, on the communications protocols used to transmit or receive signals via the antenna(s) 634. Non-limiting examples of suitable antennas may include directional antennas, non-directional antennas, dipole antennas, folded dipole antennas, patch antennas, multiple-input multiple-output (MIMO) antennas, or the like. The antenna(s) 634 may be communicatively coupled to one or more transceivers 612 or radio components to which or from which signals may be transmitted or received. Antenna(s) 634 may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals including BLE signals, a Near Field Communication (NFC) antenna for transmitting or receiving NFC signals, a 900 MHz antenna, and so forth.

The transceiver(s) 612 may include any suitable radio component(s) for, in cooperation with the antenna(s) 634, transmitting or receiving radio frequency (RF) signals in the bandwidth and/or channels corresponding to the communications protocols utilized by the controller 600 to communicate with other devices. The transceiver(s) 612 may include hardware, software, and/or firmware for modulating, transmitting, or receiving—potentially in cooperation with any of antenna(s) 634—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 612 may further include hardware, firmware, or software for receiving GNSS signals. The transceiver(s) 612 may include any known receiver and baseband suitable for communicating via the communications protocols utilized by the controller 600. The transceiver(s) 612 may further include a low noise amplifier (LNA), additional signal amplifiers, an analog-to-digital (A/D) converter, one or more buffers, a digital baseband, or the like.

Referring now to functionality supported by the various program module(s) depicted in FIG. 6, the implementation module(s) 626 may include computer-executable instructions, code, or the like that responsive to execution by one or more of the processor(s) 602 may perform functions including, but not limited to, overseeing coordination and interaction between one or more modules and computer executable instructions in data storage 620, determining user selected actions and tasks, determining actions associated with user interactions, determining actions associated with user input, initiating commands locally or at remote devices, and the like.

The relay module(s) 627 may include computer-executable instructions, code, or the like that responsive to execution by one or more of the processor(s) 602 may perform functions including, but not limited to, actuating the relays and logging a position of each relay. The transformer module(s) 628 may include computer-executable instructions, code, or the like that responsive to execution by one or more of the processor(s) 602 may analyze transformer signals, maintain a database of normal transformer and/or current values, and may compare transformer signals to such normal values.

The communication module(s) 628 may include computer-executable instructions, code, or the like that responsive to execution by one or more of the processor(s) 602 may perform functions including, but not limited to, communicating with one or more devices, for example, via wired or wireless communication, communicating with mobile devices, communicating with servers (e.g., remote servers), communicating with remote datastores and/or databases, sending or receiving notifications or commands/directives, communicating with cache memory data, communicating with user devices, and the like.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components, including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines, and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

We claim:

1. A method for load balancing a three-phase electric water heater having an electrical connection with three legs, the method comprising:
determining a plurality of current values from a plurality of current transformers disposed on the electrical connection;
comparing the plurality of current values to a current threshold value;
determining that a first current value of the plurality of current values does not satisfy the current threshold value;
determining a first heating element corresponding to the first current value, the first heating element disposed on a first leg of the electrical connection;
determining a first and second counterpart heating element, the first counterpart heating element disposed on a second leg of the electrical connection and the second counterpart heating element disposed on a third leg of the delta connection; and
causing the first and second counterpart heating elements to deactivate to balance an electrical load of the electrical connection,
wherein the electrical connection is a delta or star connection.

2. The method of claim 1, further comprising:
determining a first relay corresponding to the first heating element; and
causing the first relay to deactivate the first heating element.

3. The method of claim 1, wherein a first relay is in electrical communication with the first counterpart heating element and a second relay is in electrical communication with the second counterpart heating element, and the method further comprises activating the first relay to deactivates the first counterpart heating element and activating the second relay to deactivate the second counterpart heating element.

4. The method of claim 1, wherein the each of the first, second, and third leg of the electrical connection each have more than one heating element.

5. The method of claim 1, wherein each of the first, second, and third leg of the electrical connection each have two heating elements arranged in parallel.

6. The method of claim 1, further comprising generating a message indicative of reduced power output of the electric water heater.

7. The method of claim 6, further comprising sending the message to at least one of a mobile device and a remote server.

8. The method of claim 6, further comprising generating a graphic representation indicative of reduced power output of the electric water heater for display on one or more of a mobile device and a display of the electric water heater.

9. The method of claim 1, wherein a first current transformer of the plurality of current transformers is in electrical communication with the first heating element and the first current transformer is a current transformer ring.

10. The method of claim 1, further comprising:
determining a plurality of second current values from the plurality of current transformers;
comparing the plurality of second current values to a second current threshold, the second current threshold less than the current threshold;
determining a second current value of the plurality of second current values does not satisfy the second current threshold;
determining the second current value corresponds to a second heating element disposed on the second leg of the electrical connection; and
causing the first counterpart heating element disposed on the second leg to reactivate to balance an electrical load of the electrical connection,
wherein the electrical connection is a delta or star connection.

11. A system for load balancing a three-phase electric water heater having an electrical connection with three legs, the system comprising:
memory configured to store computer-executable instructions, and
at least one computer processor configured to access the memory and execute the computer-executable instructions to:
determine a plurality of current values from a plurality of current transformers disposed on the electrical connection;
compare the plurality of current values to a current threshold value;
determine a first current value of the plurality of current values does not satisfy a current threshold value;
determine a first heating element corresponding to the first current value, the first heating element disposed on a first leg of the electrical connection;
determine a first and second counterpart heating element, the first counterpart heating element disposed on a second leg of the electrical connection and the second counterpart heating element disposed on a third leg of the electrical connection; and
cause the first and second counterpart heating elements to deactivate to balance an electrical load of the electrical connection,
wherein the electrical connection is a delta or star connection.

12. The system of claim 11, wherein the at least one computer processor is further configured to access memory and execute the computer-executable instructions to:
determine a first relay corresponding to the first heating element; and
cause the first relay to deactivate the first heating element.

13. The system of claim 11, wherein a first relay is in electrical communication with the first counterpart heating element and a second relay is in electrical communication with the second counterpart heating element, and wherein the at least one computer processor is further configured to access memory and execute the computer-executable instructions to cause the first relay to deactivate the first counterpart heating element and cause the second relay to deactivate the second counterpart heating element.

14. The system of claim 11, wherein the each of the first, second, and third leg of the electrical connection each have more than one heating element.

15. The method of claim 11, wherein each of the first, second, and third leg of the electrical connection each have two heating elements arranged in parallel.

16. The method of claim 11, wherein the at least one computer processor is further configured to access memory and execute the computer-executable instructions to generate a message indicative of reduced power output of the electric water heater.

17. The method of claim 16, wherein the at least one computer processor is further configured to access memory and execute the computer-executable instructions to send the message to at least one or more of a mobile device and a remote server.

18. The method of claim 16, wherein the at least one computer processor is further configured to access memory and execute the computer-executable instructions to generate a graphic representation indicative of reduced power output of the electric water heater for display on one or more of a mobile device and a display of the electric water heater.

19. The method of claim 11, wherein a first current transformer of the plurality of current transformers is in electrical communication with the first heating element and the first current transformer is a current transformer ring.

20. The method of claim 11, wherein the at least one computer processor is further configured to access memory and execute the computer-executable instructions to:
determine a plurality of second current values from the plurality of current transformers;
compare the plurality of second current values to a second current threshold, the second current threshold less than the current threshold;
determine a second current value of the plurality of second current values does not satisfy the second current threshold;
determining the second current value corresponds to a second heating element disposed on the second leg of the electrical connection; and
causing the first counterpart heating element disposed on the second leg to reactivate to balance an electrical load of the electrical connection.
